(19) United States
(12) Patent Application Publication
(10) Pub. No.: US 2007/0108912 A1
(43) Pub. Date: May 17, 2007

(54) Device for containing arc tube ruptures in lamps

(76) Inventors: James A. Leonard, Shaker Heights, OH (US); Charles R. Stallman, Eastlake, OH (US)

Correspondence Address: FAY SHARPE LLP, 1100 SUPERIOR AVENUE, SEVENTH FLOOR, CLEVELAND, OH, 44114, US

(21) Appl. No.: 11/280,674

(22) Filed: Nov. 16, 2005

(51) Int. Cl. H01J 61/30; H01J 17/16

(52) U.S. Cl. 313/634

(57) ABSTRACT

A discharge lamp including an arc tube having an elongated body enclosing a discharge chamber. The discharge chamber receiving first and second electrodes therein for forming an arc discharge in the discharge chamber. The lamp also including an outer envelope having an envelope cavity therein. A support member is received in the envelope cavity for supporting the arc tube. A containment member extends from the support member and is received around at least a portion of the elongated body of the arc tube. Additionally, a method of manufacturing a discharge lamp is disclosed.

The present invention relates to the art of discharge lamps and, more particularly, to an improved device for containing arc tube ruptures in such lamps.

### BACKGROUND OF THE INVENTION

Arc tubes in high-intensity discharge (HID) lamps operate at a high temperature (on the order of approximately 1000° C. and greater) and high pressure (on the order of approximately 5 atmospheres and greater). On occasion, the arc tube ruptures. Containment devices for absorbing the kinetic energy of fragments from ruptured arc tubes are well known and commonly take various forms and/or configurations. However, these containment devices suffer from a number of shortcomings and disadvantages that can limit the effectiveness of the same. Additionally, these shortcomings and disadvantages ultimately increase the costs associated with the manufacture and production of the resulting lamp. For example, quartz shrouds are commonly used as containment devices. A quartz shroud commonly takes the form of a hollow cylinder and is positioned along the exterior of the arc discharge tube. The shroud can typically be supported around the arc tube in any suitable manner. It is well known that arc discharge tubes made from quartz generally fracture into relatively small particles having minimal kinetic energy due, at least in part, to the relatively small mass of these fragments. As such, containment devices, such as quartz shrouds, are suitable for absorbing the kinetic energy of these particles. However, arc discharge tubes formed from ceramic materials commonly fracture into a few relatively large pieces. Certain known containment devices, such as quartz shrouds, are less well suited for absorbing the kinetic energy of these objects, as the same can cause the rupture of the shroud.

In an effort to overcome this issue, containment wires have been wrapped or otherwise extended around the exterior of the quartz shroud. Generally, the containment wire sufficiently absorbs the kinetic energy of the relatively large ceramic pieces. However, the wire acts on these pieces only after the same have exceeded the envelope of the quartz shroud. As such, the formation of quartz fragments remains an issue. The use of quartz shrouds for containment has the additional disadvantage of adding considerable cost and weight to the lamp.

In other arrangements, the containment wire is supported directly on the ceramic arc discharge tube, thus entirely eliminating the quartz shroud the lamp. Typically, arc discharge tubes have legs that are of a smaller diameter than the elongated body of the arc tube. As such, the containment wire in known arrangements is wrapped around one of the legs, along the elongated body of the arc tube, and then around the other leg. However, because the legs are a smaller diameter than the body of the arc tube and the wires are wrapped around both the body and each of the legs, the wire cannot typically be prefabricated and simply assembled onto the arc tube. Rather, the containment wire is usually physically wrapped, wound or otherwise formed around the body and legs of the arc discharge tube. One disadvantage is that such arrangements are difficult and expensive to manufacture. This is due, at least in part, to the handling requirements that are commonly associated with arc discharge tubes. As such, significant care is commonly exercised during the wrapping or forming operation. Such processes are inherently less efficient than an arrangement in which the containment wire is prefabricated and later associated with the arc tube during the assembly process.

### SUMMARY OF THE INVENTION

A high-intensity discharge lamp is provided that includes an arc tube, an outer envelope having an envelope cavity therein, a support member received in the envelope cavity for supporting the arc tube, and a containment member extending from the support member. The arc tube has an elongated body enclosing a discharge chamber. The discharge chamber receives first and second electrodes therein for forming an arc discharge in the discharge chamber. The containment member is received around at least a portion of the elongated body of the arc tube.

A method of manufacturing a high-intensity discharge lamp is also provided. The method includes the steps of supplying an arc tube having an elongated body enclosing a discharge chamber, a support member for supporting the arc tube, a containment member for containing the arc tube in the event of a rupture, and an outer envelope having an envelope cavity. The elongated body of the arc tube has an exterior wall. Other steps include forming the containment member into an arrangement suitable for containing the arc tube and positioning the containment member along the exterior wall of the elongated body of the arc tube. Further steps include supporting the arc tube on the support member, attaching the containment member to the support member, and enclosing the support member, the arc tube and the containment member within the envelope chamber of the outer envelope.

### BRIEF DESCRIPTION OF THE DRAWINGS

FIG. 1 is a side elevation view of a lamp having a containment member of the present invention.

FIG. 2 is a side elevation view of the arc discharge tube and containment member arrangement shown in FIG. 1.

FIG. 3 is a side elevation view of another embodiment of an arc discharge tube and containment member arrangement.

FIG. 4 is a side elevation view of still another embodiment of an arc discharge tube and containment member arrangement.

FIG. 5 is a side elevation view of yet another embodiment of an arc discharge tube and containment member arrangement.

FIG. 6 is a side elevation view of a further embodiment of an arc discharge tube and containment member arrangement.

FIG. 7 is a side elevation view of still a further embodiment of an arc discharge tube and containment member arrangement.

FIG. 8 is a side elevation view of yet a further embodiment of an arc discharge tube and containment member arrangement.

FIG. 9 is a side elevation view of another embodiment of an arc discharge tube and containment member arrangement.

FIG. 10 is a side elevation view of still another embodiment of an arc discharge tube and containment member arrangement.

### DETAILED DESCRIPTION OF THE INVENTION

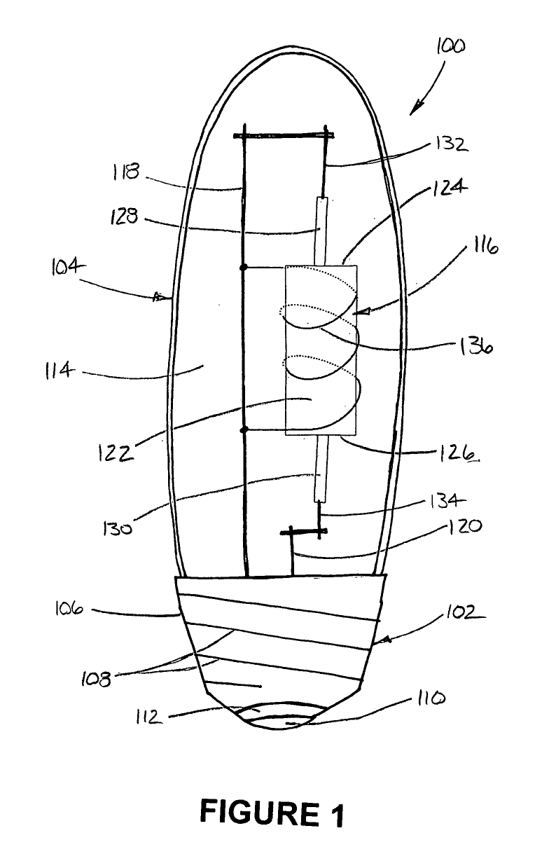

FIG. 1 illustrates a high-intensity discharged lamp 100 having a base 102 and an outer envelope 104 supported on the base. Base 102 includes a body 106 having a plurality of threads 108 formed thereon. However, it will be appreciated that any suitable arrangement for interengaging the base with a corresponding lamp socket can be used. An electrical contact 110 is provided on base 102 and is electrically insulated from body 106 by insulating material 112.

Outer envelope 104 forms an envelope cavity 114 in which an arc discharge tube 116 is supported on support members 118 and 120. Arc discharge tube 116 includes an elongated body 122 having opposing end walls 124 and 126 and at least partially defining an arc discharge chamber (not shown). Legs 128 and 130 extend from end walls 124 and 126, respectively, in this double-ended arc tube arrangement. Lead 132 extends from leg 128 and is supported on support member 118. Lead 134 similarly extends from leg 130 and is supported on support member 120. A pair of spaced apart electrodes (not shown) extends into the arc discharge chamber (not shown) for forming an arc discharge therein in a manner well known in the art. Each of the electrodes is in electrical communication with a different one of leads 132 and 134. A containment member or wire 136 extends from support member 118 and is received around elongated body 122 of discharge tube 116.

It will be appreciated that base 102, outer envelope 104, discharge tube 116 and support members 118 and 120 of lamp 100 are all of typical construction and respectively formed from materials well known to those of skill in the art. As such, further details of these materials and other structural features are not provided herein.

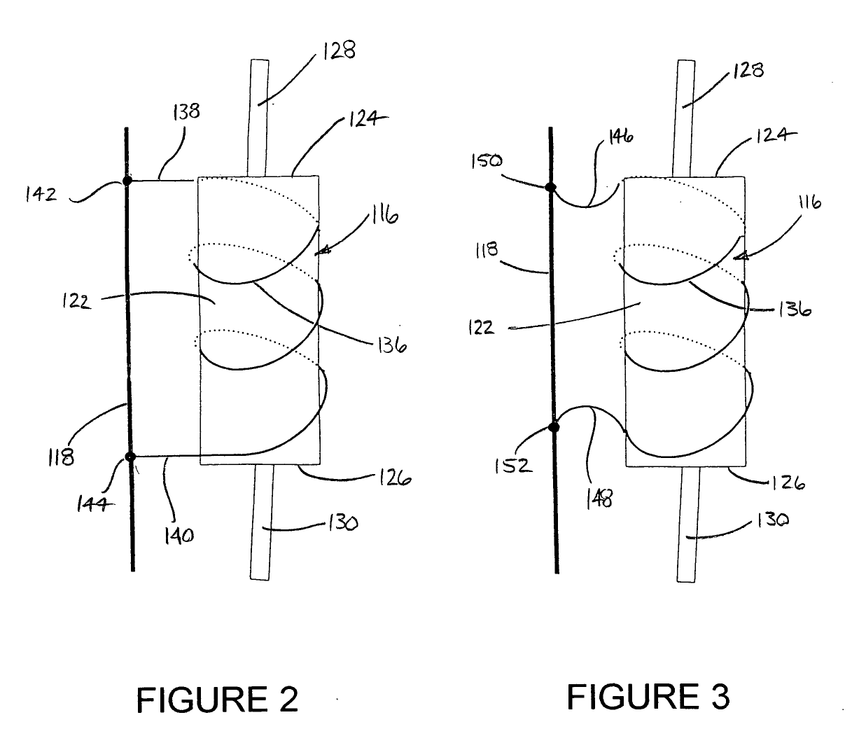

FIGS. 2-10 illustrate various embodiments of containment member and arc discharge tube arrangements. Each of these figures includes an arc discharge tube 116 having opposing end walls 124 and 126 with legs 128 and 130 respectively extending therefrom. Support member 118 is also shown in FIGS. 2-10 and supports arc discharge tube 116 as shown in and described with regard to FIG. 1 in conjunction with support member 120 (FIG. 1).

As shown in FIG. 2, containment member 136 extends from support member 118 and is wrapped helically around elongated body 122 of discharge tube 116. The helical configuration is used to minimize the shadows created by the containment member. The containment member includes two linearly extending end portions 138 and 140 respectively supported on support member 118 in spaced relation to one another at attachment points 142 and 144. It will be appreciated that securing the containment member to the support member can improve the robustness of the lamp by helping to support the arc discharge tube.

The embodiment shown in FIG. 3 is similar to that shown in and described with regard to FIG. 2. As shown in FIG. 3, containment member 136 helically extends around elongated body 122 of arc discharge tube 116 in a manner similar to that shown in and described with regard to FIG. 2. However, the containment member in FIG. 3 has end portions 146 and 148 that extend in a curvilinear manner and form at least a portion of a loop between support member 118 and elongated body 122. End portions 146 and 148 are respectively supported on support member 118 in spaced relation to one another at attachment points 150 and 152. The curvilinear end portions 146, 148 provide some limited capacity for expansion, thus absorbing kinetic energy if a non-passive failure or rupture occurs.

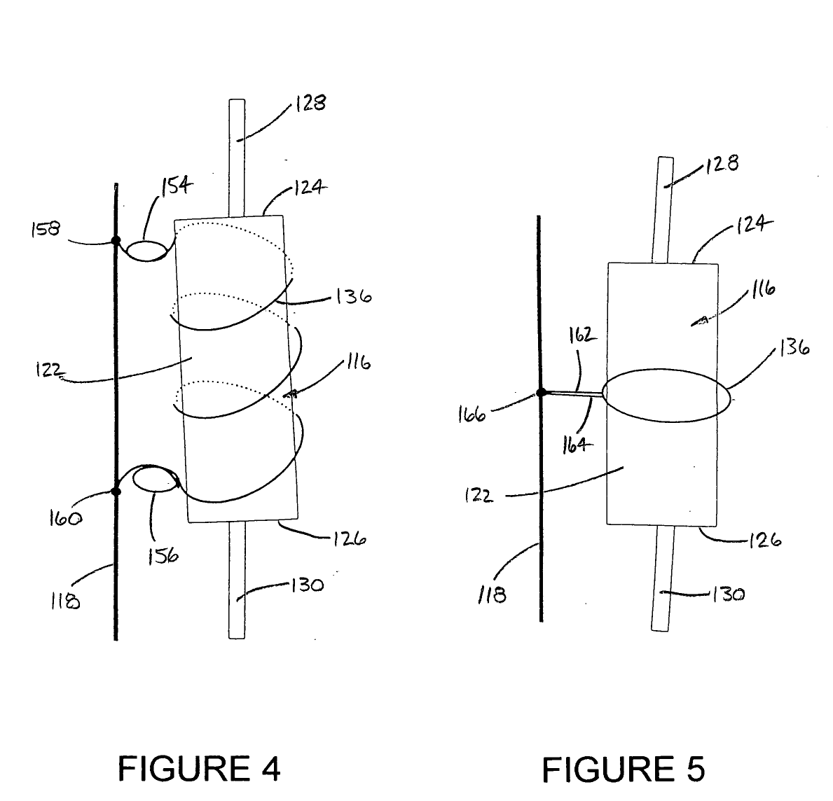

FIG. 4 illustrates an arc tube and containment member arrangement similar to that shown in and described with regard to FIG. 3 in which containment member 136 extends helically along elongated body 122 of arc discharge tube 116. However, the containment member in FIG. 4 has end portions extending along curvilinear paths each substantially forming loops 154 and 156 between support member 118 and elongated body 122. It will be appreciated from FIG. 4 that the end portions of containment member 136 are supported on support member 118 in spaced relation at attachment points 158 and 160.

Another embodiment of an arc discharge tube and containment member arrangement in accordance with the present invention is shown in FIG. 5, containment member 136 extends around elongated body 122 of arc discharge tube 166 forming a single loop therearound. The containment member has linearly extending end portions 162 and 164 extending between support member 118 and elongated body 122 and is supported on the support member at attachment point 166.

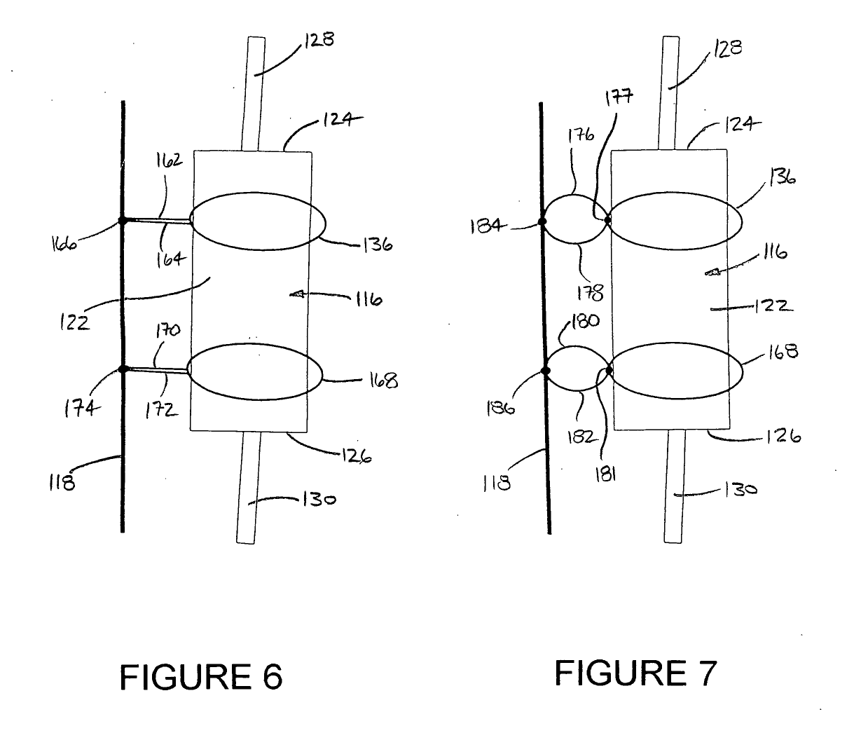

The arc tube and containment member arrangement shown in FIG. 6 is substantially similar to that shown in and described with regard to FIG. 5. However, the arrangement in FIG. 6 includes a second containment member 168 extending around elongated body 122 in spaced relation to containment member 136. Containment member 136 has linearly extending end portions 162 and 164 extending between support member 118 and elongated body 122. End portions 162 and 164 are supported on support member 118 at attachment point 166. Similarly, containment member 168 has two linearly extending end portions 170 and 172 extending between support member 118 and elongated body 122. End portions 170 and 172 are supported on support member 118 at attachment point 174.

Turning now to FIG. 7, the arrangement includes an arc discharge tube 116 and containment members 136 and 168 similar to those described with regard to FIG. 6. However, the arrangement in FIG. 7 differs from that in FIG. 6 in that containment member 136 includes curvilinear end portions 176 and 178 and containment member 168 includes curvilinear end portions 180 and 182 rather than the linearly extending portions shown in FIG. 6. End portions 176 and 178 of containment member 136 each form at least a portion of a loop and are each supported on support member 118 at attachment point 184. Similarly, end portions 180 and 182 of containment member 168 each also form at least a portion of a loop and are supported on support member 118 at attachment point 186.

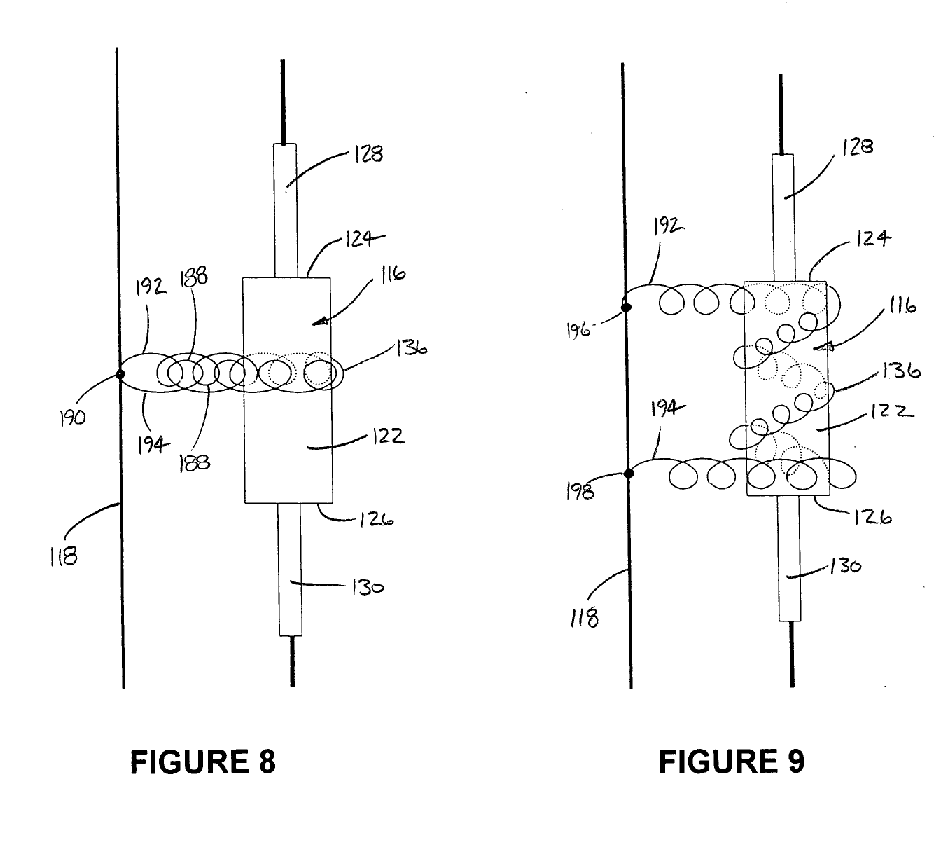

FIG. 8 illustrates yet another embodiment of an arc discharge tube and containment member arrangement. Containment member 136 includes a plurality of coils 188 and extends around at least a portion of elongated body 122 of arc discharge tube 116. Containment member 136 includes end portions 192 and 194 that extend in a curvilinear manner and are supported on support member 118 at attachment point 190. FIG. 9 illustrates an arc discharge tube 116 having a containment member 136 that extends helically around elongated body 122. Containment member 136 includes a plurality of coils 188 extending therealong between curvilinear end portions 192 and 194. End portions 192 and 194 in FIG. 9 are respectively supported on support member 118 at attachment points 196 and 198. The plurality of coils shown in FIGS. 8 and 9 extend substantially along the entire length of containment member 136 including curvilinear end portions 192 and 194. However, it will be appreciated that any suitable number of coils can be used and that substantially linear portions can be used and/or form a part of containment member 136.

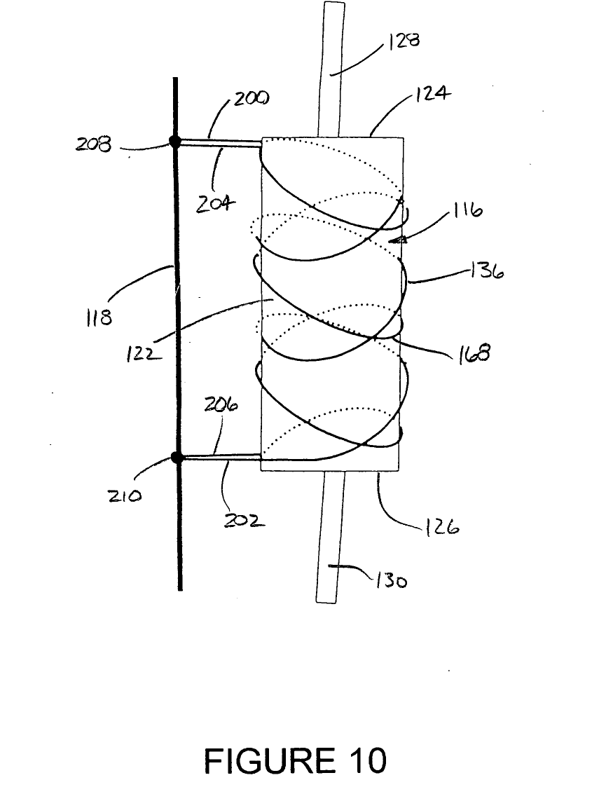

Another embodiment of an arc discharge tube and containment member arrangement is shown in FIG. 10. The arrangement includes an arc discharge tube 116 and containment members 136 and 168 extending helically along elongated body 122 thereof. Containment member 136 includes substantially linearly extending end portions 200 and 202 extending from and supported on support member 118. Similarly, containment member 168 includes substantially linearly extending end portions 204 and 206 extending from and supported on support member 118. As is apparent from FIG. 10, containment members 136 and 168 extend along elongated body 122 in a substantially double helix-type arrangement. The end portions of each containment member are supported on support member 118 in spaced relation to one another. As such, end portions 200 and 204 are supported on support member 118 at attachment point 208, and end portions 202 and 206 are supported on support member 118 at attachment point 210.

As shown in FIGS. 2-10, the end portions of the containment members are supported on or secured to support wire 118 at the associated attachment points. The end portions are secured to the support member at the respective attachment points in any suitable manner and by using any suitable process or materials. In one embodiment, the end portions are welded to the support member. Additionally, it will be appreciated that while the end portions are shown and described herein as being attached to the support member in various positions relative to one another, any suitable positions, configurations or other arrangements can be used. For example, end portions 138 and 140 shown in FIG. 2 are respectively attached to support member 118 at attachment points 142 and 144. However, the attachment points could be positioned closer to one another or at a single point positioned substantially centrally along the support member relative to elongated body 122.

Furthermore, it will be appreciated that the containment members can be made from any suitable material and can be straight, curvilinear or coiled or any combination thereof. In one embodiment, the containment member is formed from cylindrical wire; however, it will be appreciated that any suitable shape or configuration of material can be used. Additionally, where the containment member is coiled, the pitch of the coils can be varied and optimized to provide the best containment, the least light loss, and the least expensive implementation. Additionally, where the containment member is wrapped in a helical arrangement along the body of the arc discharge tube, the number of wraps, the pitch of the wraps, the pattern of the wraps, such as helix, double helix, cross-double helix and/or simple loops, for example, can also be varied and optimized. In the preferred embodiment illustrated and described above, the containment member does not extend beyond end walls 124 and 126 or along legs 128 and 130 for ease of manufacture and assembly. Additionally, the present invention is not intended to be limited to arrangements in which the containment member extends 360 degrees or more around the elongated body of the arc discharge tube. Rather, any suitable arrangement can be used. For example, in one preferred embodiment shown in FIG. 8, the containment member extends at least about 180 degrees around the body of the arc discharge tube.

The embodiment shown in FIG. 1 has the advantage of minimizing the shadows created by the containment member in many lamp arrangements. However, containment can be improved if the containment member has some limited capacity for expansion, thus absorbing the energy of the rupture. As such, various configurations, including, but not limited to, those shown in FIGS. 3, 4 and 7-9, can optionally include at least a portion of one or more loops or coils or alternative configuration that functions to provide excess material for expansion. In other arrangements, such as those shown in FIGS. 5, 6 and 7, one or more extra welds can optionally be provided near the arc tube, such as welds 177 and 181 shown in FIG. 7, for example, to hold the looped portion of the containment member tightly closed.

While considerable emphasis has been placed on the preferred embodiments of the invention illustrated and described here, it will be appreciated that other embodiments can be made and that many modifications can be made in the embodiments shown and described without departing from the principles of the present invention. Obviously, such modifications and alterations will occur to others upon reading and understanding the preceding detailed description, and it is intended that the subject invention be construed as including all such modifications and alterations insofar as they come within the scope of the appended claims or the equivalents thereof. Accordingly, it is to be distinctly understood that the foregoing descriptive matter is to be interpreted merely as illustrative of the invention and not as a limitation.

Having thus described the preferred embodiments, the invention is now claimed to be:

1. A high-intensity discharge lamp comprising:
an arc tube having an elongated body enclosing a discharge chamber, said discharge chamber receiving first and second electrodes therein for forming an arc discharge in said discharge chamber;
an outer envelope having an envelope cavity therein;
a support member received in said envelope cavity for supporting the arc tube therein; and,
a containment member extending from said support member and received around at least a portion of said elongated body of said arc tube.

2. The invention according to claim 1, wherein said support member is a wire.

3. The invention according to claim 1, wherein said containment member is a wire.

4. The invention according to claim 3, wherein said wire has a pair of opposing ends and each of said ends is attached to said support member.

5. The invention according to claim 4, wherein said opposing ends of said wire are attached to said support member in spaced relation to one another.

6. The invention according to claim 1, wherein said elongated body of said arc tube includes opposing end walls and an arc tube leg extending from each of said end walls of said elongated body.

7. The invention according to claim 1, wherein said containment member extends around said elongated body of said arc tube at least about 360 degrees.

8. The invention according to claim 1, wherein said containment member extends around said elongated body in a substantially helical manner.

9. The invention according to claim 1, wherein said containment member extends substantially linearly between said support member and said elongated body of said arc tube.

10. The invention according to claim 1, wherein said containment member extends along a generally curvilinear path between said support member and said elongated body of said arc tube.

11. The invention according to claim 1, wherein said containment member is a first containment member and said high-intensity discharge lamp is further comprised of a second containment member.

12. The invention according to claim 11, wherein said first and said second containment members extend around said elongated body of said arc tube in a substantially double-helix arrangement.

13. A method of manufacturing a high-intensity discharge lamp comprising the steps of:
supplying an arc tube having an elongated body enclosing a discharge chamber, a support member for supporting said arc tube, a containment member for containing said arc tube in the event of a rupture thereof, and an outer envelope having an envelope cavity, said elongated body having an exterior wall;
forming said containment member into an arrangement suitable for containing said arc tube;
positioning said containment member along said exterior wall of said elongated body of said arc tube;
supporting said arc tube on said support member;
attaching said containment member to said support member; and,
enclosing said support member, said arc tube and said containment member within said envelope chamber of said outer envelope.

14. The invention according to claim 13 further comprising a step of forming at least a portion of a coil along at least a portion of said containment member.

15. The invention according to claim 14, wherein said containment member is a wire having opposing ends, and said step of forming at least a portion of a coil includes forming said portion adjacent one of said opposing ends of said wire.

16. The invention according to claim 13, wherein said containment member is a first containment member, said method further comprising the steps of supplying a second containment member forming said second containment member into an arrangement suitable for containing said arc tube and positioning said second containment member along at least a portion of said exterior wall of said elongated body of said arc tube.

17. The invention according to claim 16, wherein said first and said second containment members extend along said elongated body in a substantially double-helix arrangement.

18. The invention according to claim 16 further comprising a step of attaching said first and said second containment members to said support member.

19. An improved high-intensity discharge lamp having an outer envelope with an envelope cavity, a support member received within said envelope cavity, an arc tube supported on said support member, and a containment member, the improvement comprising:
said containment member extending around at least a portion of said arc tube and being supported on said support member.

20. The invention according the claim 19, wherein said containment member is a wire having opposing ends and each of said opposing ends are attached to said support member in spaced relation to one another.
